(19) United States
(12) Patent Application Publication
(10) Pub. No.: US 2013/0231890 A1
(43) Pub. Date: Sep. 5, 2013

(54) METHOD AND DEVICE FOR CONTROLLING AN APPARATUS

(71) Applicants: Daniel Schifferdecker, Tuebingen (DE); Fouad Bennini, Reutlingen (DE); Julian Bartholomeyczik, Reutlingen (DE); Sergej Scheiermann, Eningen (DE)

(72) Inventors: Daniel Schifferdecker, Tuebingen (DE); Fouad Bennini, Reutlingen (DE); Julian Bartholomeyczik, Reutlingen (DE); Sergej Scheiermann, Eningen (DE)

(21) Appl. No.: 13/819,287

(22) PCT Filed: Jul. 14, 2011
(86) PCT No.: PCT/EP2011/062025

§ 371 Date: May 17, 2013

(30) Foreign Application Priority Data
Aug. 26, 2010 (DE) 10 2010 039 837.3

(51) Int. Cl. G05B 15/02; G01P 15/00

(52) U.S. Cl. CPC G05B 15/02; G01P 15/00
USPC 702/141

(57) ABSTRACT

A method is provided for controlling an electric apparatus having a sensor unit, the apparatus being operated in a first potential motion mode and/or in a second potential motion mode; a sensor signal being generated in the sensor unit; the first information and/or the second information being calculated as function of the sensor signal, as a function of a requirement for providing a first information with respect to the presence of the first potential motion mode and/or a second information with respect to the presence of the second potential motion mode.

### FIELD OF THE INVENTION

The present invention relates to a method and device for controlling an apparatus.

### BACKGROUND INFORMATION

For controlling apparati, sensors are standard components in mobile telephones, safety applications and health applications. Combinations of various sensors, so-called sensor clusters, which are controlled by “smart software”, are bursting onto the market, mobile telephones, for example, being equipped with accelerometer sensors, magnetic sensors and gyroscopes, together with “smart software”. The customer experience and the value to the customer are determined by the application software and/or so-called “use cases”, which use the data generated by the combined sensors and the results calculated by the software. Therefore, the software is the key component, which may be implemented in a microcontroller that operates the sensors, or present in the system CPU (such as a

Linux library in an Android mobile telephone) or as a user-installed application. Applications, such as portrait/landscape image orientation, compass or contact detection, are usually implemented as independent software packages, and require, each for itself, raw input data from the various sensors. U.S. Pat. No. 6,525,658 B2 describes the identification of events starting from various sensor types, but no assignment is described of events to higher-order applications.

Conventionally, no optimal energy-saving function is possible. The energy consumption is determined by the watch of each individual sensor (the longer the sleep phases between the watch phases, the lower is the energy consumption) and by the running time of the software itself in the system CPU. When all applications are running independently of one another, the same data query and the same event calculation have to be made for each application. In this case, there is no common use of sensor data for all applications. Furthermore, for each application, filtering has to be performed (e.g., noise reduction or offset correction) whereby calculating time and storage capacity are required. Each application requires data from various sensors in various bandwidths and various readout rates to satisfy the requirements of the algorithms. In addition, there is no logic that permits deactivating particularly resource-intensive calculations when they are not needed. Furthermore, it is disadvantageous that adding or removing applications requires complete revalidation of the control software. Moreover, the replacement of sensors disadvantageously requires a new adjustment of the data query and the calculating units. Furthermore it is disadvantageously not possible to validate the calculation results against one another. Furthermore it is disadvantageously not possible for the user to create and implement his own applications. Also, it is disadvantageously not possible to synchronize the calculation results.

### SUMMARY

An example method is provided for controlling an electric apparatus having a sensor unit, the apparatus being operated in a first potential motion mode and/or in a second potential motion mode; a sensor signal being generated in the sensor unit; the first information and/or the second information being calculated as a function of the sensor signal, as a function of a requirement for providing a first information with respect to the presence of the first potential motion mode and/or a second information with respect to the presence of the second potential motion mode.

The apparatus includes, for instance, a mobile radio unit, a mobile telephone, a security or monitoring unit and/or a health monitoring unit. The first and the second motion mode include a free-fall detection and/or a rotation determination, for example. The first and/or the second information include the information “apparatus is in a free fall” and/or “apparatus has been rotated 30° about the X axis”.

The example method according to the example embodiment of the present invention has the advantage that an optimal energy-saving function is possible. The watch time of each individual sensor is considerably reducible and the running time of the software itself in the system CPU is also considerably decreasable. Since calculations do not run independently of one another, the same data query and the same event calculation no longer have to be carried out for each application. In this case, there is a common use of sensor data for all applications. Furthermore, for each application, filtering no longer has to be performed (e.g,. noise reduction or offset correction) whereby calculating time and storage capacity are considerably reduced. In addition, there is a logic that permits deactivating particularly resource-intensive calculations when they are not needed. Furthermore, adding or removing applications is possible without complete revalidation of the control software. Moreover, the replacement of sensors requires no new adjustment of the data query and the calculating units. Furthermore it is possible to validate the calculation results with respect to one another.

Furthermore it is possible for the user to create and implement his own applications. Furthermore it is possible to synchronize the calculation results.

A large number of applications (contact detection, pace counting) are based on a set of fundamental events. An event is, for example, a yaw rate boundary value that is exceeded on an axis of a gyrometer, but also a rapid temperature change or a change in a magnetic field.

According to one preferred refinement, it is provided that, in a processing unit, as a function of the sensor signal a first event is determined corresponding to the first potential motion mode and/or a second event is determined corresponding to the second potential motion mode This advantageously enables a particularly efficient reduction in calculating time. The first result and/or the second result are preferably used to trigger and/or control the calibration of the sensor signal. This advantageously enables a particularly efficient calibration of the sensor signal.

According to another preferred refinement, it is provided that, for the generation of the sensor signal in the sensor unit, an acceleration sensor, a magnetic field sensor, a gyroscope, a pressure sensor and/or an approach sensor be used. This advantageously makes usable every conventional sensor type when using the method according to the present invention.

According to one further development, it is provided that the sensor signal be filtered and/or stored, preferably a first frequency bandwidth being stored in a first memory unit and a second frequency bandwidth being stored in a second memory unit; further preferred, for determining the first event, the first memory unit being accessed and/or for determining the second event, the second memory unit being accessed. Because of that, it is advantageously possible to have particularly efficient storage and access.

According to one refinement, it is provided that the sensor signal is calibrated and/or corrected, preferably a 0 g offset correction being carried out. This advantageously enables a particularly efficient preparation of the sensor signal.

According to one preferred refinement, it is provided that the requirement on providing is produced by an application. The requirement for providing is preferably produced by a user input. This advantageously makes possible a particularly efficient implementation in an application and/or in a user-machine interface.

An additional subject matter of the present invention relates to a device for controlling an electric apparatus, the device having a sensor unit; the apparatus being operable in a first potential motion mode and/or in a second potential motion mode; a sensor signal being able to be generated in the sensor unit; the first information and/or the second information being calculated as function of the sensor signal, as a function of a requirement for providing a first information with respect to the presence of the first potential motion mode and/or a second information with respect to the presence of the second potential motion mode.

An optimal energy-saving function is advantageously possible.

The watch time of each individual sensor is considerably reducible and the running time of the software itself in the system CPU is also considerably decreasable. Since calculations do not run independently of one another, the same data query and the same event calculation no longer have to be carried out for each application. In this case, there is a common use of sensor data for all applications. Furthermore, for each application, filtering no longer has to be performed (e.g., noise reduction or offset correction) whereby calculating time and storage capacity are considerably reduced. In addition, there is a logic that permits deactivating particularly resource-intensive calculations when they are not needed. Furthermore, adding or removing applications is possible without complete revalidation of the control software. Moreover, the replacement of sensors requires no new adjustment of the data query and the calculating units. Furthermore it is possible to validate the calculation results with respect to one another. Also, it is possible for the user to create and implement his own applications. Furthermore it is possible to synchronize the calculation results.

According to another preferred refinement, it is provided that the sensor unit include an acceleration sensor, a magnetic field sensor, a gyroscope, a pressure sensor and/or an approach sensor. This advantageously makes usable every conventional sensor type when using the device according to the present invention.

According to another preferred refinement, it is provided that the device have a processing unit, in the processing unit, as a function of the sensor signal, a first event corresponding to the first potential motion mode and/or a second event corresponding to the second potential motion mode being determinable, the first event and/or the second event being usable for triggering and/or controlling the calibration of the sensor signal. Because of that, an especially efficient reduction in the calculating time as well as a particularly efficient calibration of the sensor signal is advantageously possible.

Exemplary embodiments of the present invention are illustrated in the figure and explained in greater detail below.

### BRIEF DESCRIPTION OF THE DRAWING

FIG. 1 shows a block diagram of an exemplary specific embodiment of the present invention.

### DETAILED DESCRIPTION OF EXAMPLE EMBODIMENTS

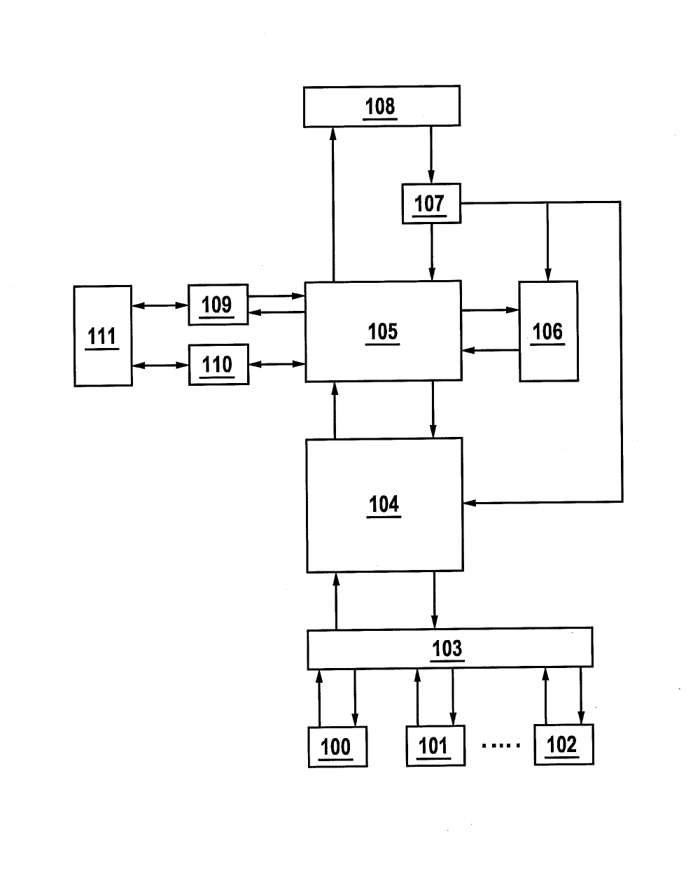

FIG. 1 shows a block diagram of an exemplary specific embodiment of the present invention. Blocks 100, 101, 102 (also called sensor units below) represent sensors as, for example, an acceleration sensor, a magnetic field sensor, a gyroscope, a pressure sensor and/or an approach sensor. Block 103 is used as an abstraction layer between the sensors and data processing block 104 (named also first and second memory unit below). Data processing block 104 includes a data buffer, a sensor calibration and a data correction for each sensor. The data buffer stores recently queried raw data for each sensor. Two or more data buffers are preferably used per sensor, acceleration data of, for instance, 1000 Hz bandwidth, low-pass filter data to 200 Hz and to 10 Hz being stored in different data buffers. A sensor calibration is arranged for each sensor, which continuously observes the raw data and calculates error parameters such as a 0 g offset or sensitivity deviations. In the data correction, the raw data are corrected as a function of the calculated error parameters. All applications access the calibrated and corrected sensor data, which are calculated only once. Data processing block 104 includes a calculation block which calculates higher value results, for example, the geomagnetic alignment is determined based on tilt/roll data from an acceleration sensor and magnetic field data of a geomagnetic sensor. The calibrated data, such as acceleration data and the results, such as the geomagnetic alignment are provided to higher layers via central control unit 105. Central control unit 105
queries data from data processing block 104,
provides data of an event detecting machine 108 (called a processing unit below),
activates/deactivates the calculation of event detectors as requested by the activated applications (when an event is not required, a calculation is deactivated to save calculating time),
automatically switches off the sensors that are not required, or switches them into the energy-saving mode;

because of that, the host system does not have to monitor the energy saving, whereby the software integration is considerably simplified,
calls up the resource-intensive calculations only if they are absolutely necessary,
sends the results (calibrated data, application results and events) to the host system via UMM (unified memory map), UMM being a structured RAM section and
includes user configurations of host systems via the UMM and changes the system configuration accordingly (activates/deactivates applications).

A large number of applications (contact detection, pace counting) are based on a set of fundamental events. An event is, for example, a yaw rate boundary value that is exceeded on an axis of a gyrometer, but also a rapid temperature change or a change in a magnetic field. The calculation of the applications is based on these basis events, because these have to be calculated only once, and are able to be used as input for many applications, whereby calculating time may advantageously be saved. Event detection machine 108 observes the calibrated data buffers of all sensors and associated event detection units continuously calculate whether a certain event is occurring. These detected events are shifted into block 107, which includes the currently detected event. Central control unit 105 observes the detected event and only calls off the application that is connected with this detected event. As long as the triggering event does not occur, the application is not activated.

The example of a double tap is given to clarify the present invention. An acceleration sensor is used for the detection of a double tap on an apparatus. In the at-rest state, the event is registered as “stable”. If the apparatus is tapped, a rise in the acceleration data is measured, this rise being registered by a “rise” event detector. Carrying out the application “double tap” is triggered by the event “rise”, the application expecting two successive “stable” events and an additional “rise” event followed by a stable event. This corresponds to a double tap. As long as there is no “rise” event, the application is not carried out, whereby calculating time is saved. As soon as the logical chain is interrupted, the application is stopped and deactivated again. The detected event is preferably restored into data processing block 104, in order to start and/or control the calibration of the sensor data (for instance, the calibration of the acceleration sensor is triggered after a temperature change has been detected). Furthermore, plausibility checks are possible, for example, Event 1 (“apparatus stable, not moved dynamically”) excludes Event 2 (“apparatus is accelerated at 1.5 g”). That is, when Event 1 is detected, the calculation of Event 2 is able to be deactivated. Furthermore, the events may be used as a high order program language. Instead of evaluating raw data, one may simply use the events in order to implement new applications, whereby the user is able to implement his own applications in a simple manner.

Application unit 106 includes the current application logic, the application results being calculated based on events that have been transmitted by event detection machine 108, and optionally on calibrated data of data processing block 104. Application unit 106 is only called up when it is required and “triggering events” are present. The applications are exchangeable, i.e., new applications may be added and old applications may be removed, whereby a modular structure is created. UMM 109 includes accumulated configuration data and transmitted data output, as well as event status and application results, and transmits these, structured and synchronized, to host system 111 (e.g., an application processor of a mobile radio unit). Interruption block 110 receives ERQ from host system 111 and triggers events, and transmits IRQ to host system 111 as a function of internal conditions. Internal events or application results are able to be routed to one or more (software or hardware) interruption lines. This makes possible considerable energy savings, especially when the architecture is implemented on an associated MCU. The MCU is then able to control the watch/sleep status of host system 111, based on internal results or application results.

An additional example is given to clarify the present invention. Host system 111, such as a mobile radio unit, determines that, at the present time, no application is running, which requires geomagnetic alignment (for instance, the navigation application has been closed by the user). As a consequence, application “eCompass” is deactivated in the UMM configuration by host system 111. The magnetic sensor is then deactivated, the query of the magnetic sensor data being stopped, and the calculation of the application “eCompass” being deactivated as well as the calculation of associated events being stopped. Furthermore, the acceleration sensor is deactivated. These actions advantageously take place without input by the system or the user. When the user activates the navigation application again, the host system activates the eCompass application in the UMM configuration. The magnetic sensors are automatically activated, the data query of the acceleration sensors takes place, and the application eCompass is carried out again. Event detection machine 108 observes the calibrated data continuously and if, for example, a “magnetic field interference” event is detected, an offset correction of the magnetic sensor is carried out.

1-10. (canceled)

11. A method for controlling an electric apparatus having a sensor unit, the apparatus being operated in at least one of a first potential motion mode and a second potential motion mode, the method comprising:
generating a sensor signal in the sensor unit; and
calculating, as a function of a requirement for providing at least one of the first information with respect to a presence of the first potential motion mode and the second information with respect to the presence of the second potential motion mode, at least one of a first information and a second information as a function of the sensor signal.

12. The method as recited in claim 11, further comprising:
determining at least one of a first event corresponding to the first potential motion mode and a second event corresponding to the second potential motion mode in a processing unit as a function of the sensor signal, at least one of the first event and the second event being used for at least one of triggering and controlling calibration of the sensor signal.

13. The method as recited in claim 11, wherein, for the generating of the sensor signal in the sensor unit, at least one of an acceleration sensor, a magnetic field sensor, a gyroscope, a pressure sensor and an approach sensor, are used.

14. The method as recited in claim 11, further comprising:
filtering and storing the sensor signal, a first frequency bandwidth being stored in a first memory unit, and a second frequency bandwidth being stored in a second memory unit, wherein for at least one of determining the first event, the first memory unit being accessed and for determining the second event, the second memory unit being accessed.

15. The method as recited in claim 11, further comprising: at least one of calibrating and correcting the sensor signal, a 0 g offset correction being carried out.

16. The method as recited in claim 11, wherein the requirement for providing the at least one of the first information and the second information is produced by an application.

17. The method as recited in claim 11, wherein the requirement for providing the at least one of the first information and the second information is produced by a user input.

18. A device for controlling an electric apparatus, the device including a sensor unit, wherein the apparatus is able to be operated in a first potential motion mode or in a second potential motion mode, and a sensor signal being producible in the sensor unit, wherein the device is configured to, as a function of a requirement for providing a first information with respect to the presence of the first potential motion mode and a second information with respect to the presence of the second potential motion mode, calculate at least one of the first information and the second information as a function of the sensor signal.

19. The device as recited in claim 18, wherein the sensor unit includes at least one of an acceleration sensor, a magnetic field sensor, a gyroscope, a pressure sensor, and an approach sensor.

20. The device as recited in claim 18, further comprising:
a processing unit, wherein in the processing unit is configured, as a function of the sensor signal, to determine at least one of a first event corresponding to the first potential motion mode, and a second event corresponding to the second potential motion mode, at least one of the first event and the second event being usable for at least one of triggering and controlling calibration of the sensor signal.
